(19) United States
(12) Patent Application Publication
(10) Pub. No.: US 2019/0228930 A1
(43) Pub. Date: Jul. 25, 2019

(54) LUMINOUS PRESS KEY MODULE

(71) Applicant: SUZHOU LUUMII LTD., Suzhou City (CN)

(72) Inventor: Yu-Kai LIN, Suzhou City (CN)

(21) Appl. No.: 16/055,040

(22) Filed: Aug. 4, 2018

(30) Foreign Application Priority Data
Jan. 24, 2018 (TW) 107201182

(51) Int. Cl. H01H 13/705; H01H 13/83; F21V 8/00; G06F 3/02

(52) U.S. Cl. CPC H01H 13/705; H01H 13/83; H01H 2219/036; G06F 3/0202; G02B 6/0011

(57) ABSTRACT

A luminous press key module includes a bottom plate, a keycap, a membrane circuit board, and one or more micro LEDs. The keycap is installed above the bottom plate, the membrane circuit board is installed between the bottom plate and the keycap, and the micro LED is installed and electrically coupled to the membrane circuit board and arranged corresponding to the keycap. The micro LED can be installed on the membrane circuit board directly to omit the component of the conventional light guide plate, so as to realize a light, thin, short and compact design of the luminous press key module.

### FIELD OF THE INVENTION

This disclosure relates to a press key structure, and more particularly to a luminous press key module.

### BACKGROUND OF THE INVENTION

Devices such as computer keyboards, mobile phones, computers, and control panels are generally equipped with luminous press keys, and a light emitting source is installed inside the luminous press keys for lighting up keycaps, so that users can clearly see and recognize the characters formed on the keycaps in a dark or no-light environment to reduce the chance of wrong input.

In addition, the light emitting source includes a light guide plate and a light emitting diode (LED), and the light guide plate is installed under the keycaps, and the LED is installed on a side of the light guide plate for producing light, so that the light can be guided by the light guide plate to the keycaps. The thickness of the luminous press key cannot be reduced owing to the specific thickness of the light guide plate, and because of the light loss in light guide plate structure, power consumption of the luminous key module using this method remains high. As a result, the requirements of a thin, light, compact and power saving design cannot be met.

In view of the aforementioned drawbacks of the prior art, the discloser of this disclosure based on years of experience to conduct extensive research and experiment, and finally provided a feasible solution to overcome the drawbacks of the prior art.

### SUMMARY OF THE INVENTION

This disclosure provides a luminous press key module that directly installs the micro LED on a membrane circuit board in order to omit the component of the conventional light guide plate and provides the advantageous features of a thin, light, compact and power saving design of the luminous press key module.

In an embodiment of this disclosure, this disclosure provides a luminous press key module, comprising: a bottom plate; a keycap installed above the bottom plate; a membrane circuit board, installed between the bottom plate and the keycap; and at least a micro LED, installed and electrically coupled to the membrane circuit board, the micro LED is arranged corresponding to the keycap.

Wherein, the micro LED has a small volume, so that the micro LED can be installed onto the membrane circuit board directly, and provided for transmitting light directly from a gap between the keycap and the bottom plate, or transmitting light directly to the light-transmitting material of the keycap to omit the component of the conventional light guide plate and associated light loss, so as to reduce power consumption and reduce the thickness of the luminous press key module, providing the advantageous features of a light, thin, compact and power saving design of the luminous press key module.

### BRIEF DESCRIPTION OF THE DRAWINGS

FIG. 1 is a cross-sectional view of a luminous press key module in accordance with a first embodiment of this disclosure;

FIG. 2 is a cross-sectional view of a micro LED in accordance with the first embodiment of this disclosure;

FIG. 3 is a cross-sectional view of a micro LED in accordance with a second embodiment of this disclosure;

FIG. 4 is a cross-sectional view of a luminous press key module in accordance with the second embodiment of this disclosure;

FIG. 5 is a cross-sectional view of a micro LED in accordance with a third embodiment of this disclosure;

FIG. 6 is a cross-sectional view of a luminous press key module in accordance with the third embodiment of this disclosure;

FIG. 7 is a cross-sectional view of a micro LED in accordance with a fourth embodiment of this disclosure;

FIG. 8 is a cross-sectional view of a luminous press key module in accordance with the fourth embodiment of this disclosure;

FIG. 9 is a cross-sectional view of a micro LED in accordance with a fifth embodiment of this disclosure;

FIG. 10 is a cross-sectional view of a luminous press key module in accordance with the fifth embodiment of this disclosure;

FIG. 11 is a cross-sectional view of a micro LED in accordance with a sixth embodiment of this disclosure;

FIG. 12 is a cross-sectional view of a luminous press key module in accordance with the sixth embodiment of this disclosure;

FIG. 13 is a cross-sectional view of a micro LED in accordance with a seventh embodiment of this disclosure;

FIG. 14 is a cross-sectional view of a luminous press key module in accordance with the seventh embodiment of this disclosure;

FIG. 15 is a cross-sectional view of a micro LED in accordance with an eighth embodiment of this disclosure;

FIG. 16 is a cross-sectional view of a micro LED in accordance with a ninth embodiment of this disclosure;

FIG. 17 is a cross-sectional view of a micro LED in accordance with a tenth embodiment of this disclosure; and

FIG. 18 is a cross-sectional view of a luminous press key module in accordance with the eighth embodiment of this disclosure.

### DESCRIPTION OF THE PREFERRED EMBODIMENTS

The technical contents of this disclosure will become apparent with the detailed description of preferred embodiments accompanied with the illustration of related drawings as follows. It is intended that the embodiments and figures disclosed herein are to be considered illustrative rather than restrictive.

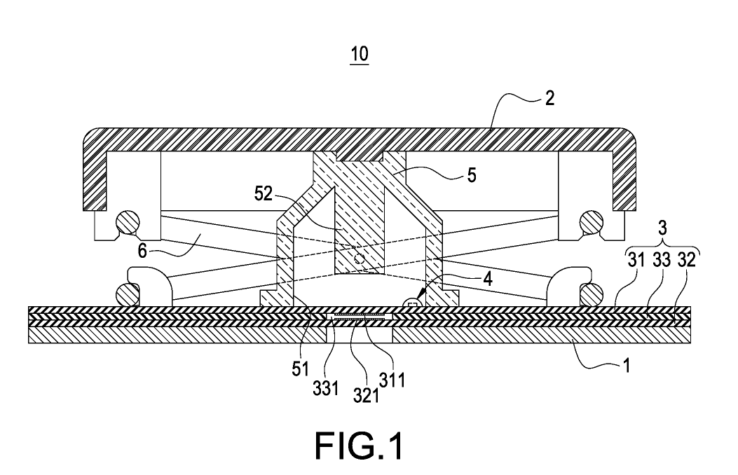

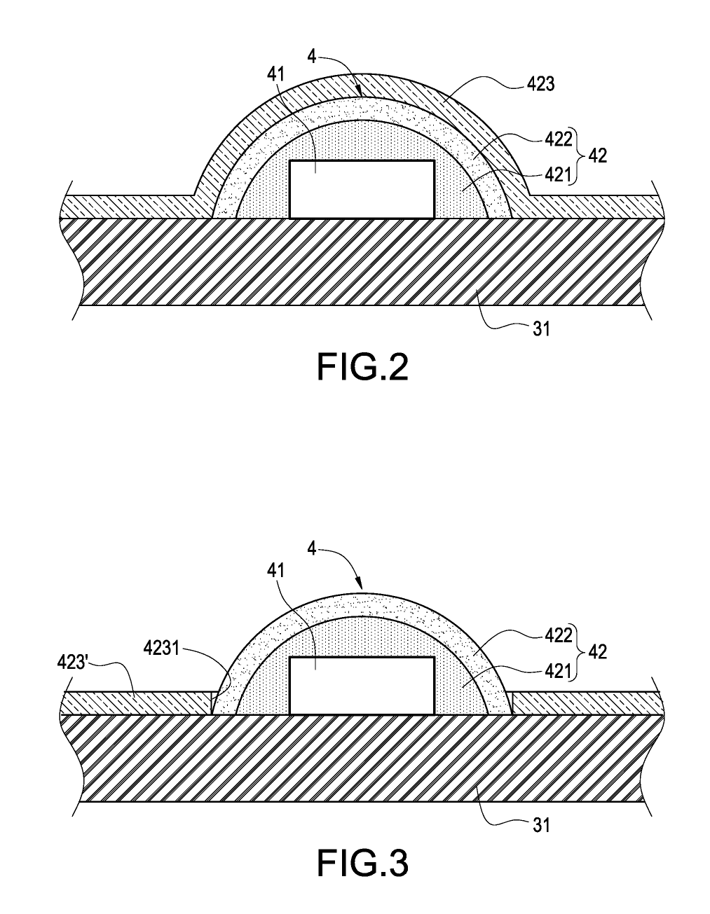

With reference to FIGS. 1 and 2 for a luminous press key module and a micro LED 4 in accordance with the first embodiment of this disclosure respectively, the luminous press key module 10 comprises a bottom plate 1, a keycap 2, a membrane circuit board 3, and one or more micro LEDs 4.

In FIG. 1, the keycap 2 is installed above the bottom plate 1, and the membrane circuit board 3 is installed between the bottom plate 1 and the keycap 2. The membrane circuit board 3 comprises an upper film 31, a lower film 32 and a spacer film 33. The spacer film 33 is held between the upper film 31 and the lower film 32. The spacer film 33 has a penetrating hole 331. The upper film 31 has a first conductive circuit 311 installed on a bottom surface of the upper film 31 and disposed corresponding to the penetrating hole 331. The lower film 32 has a second conductive circuit 321 installed on a top surface of the lower film 32 and disposed corresponding to the penetrating hole 331. The upper film 31, the lower film 32, and the spacer film 33 are thin films made of a plastic material such as PET, PC, TPU, PMMA, etc.

In FIGS. 1 and 2, the micro LED 4 is installed and electrically coupled to the membrane circuit board 3 and configured to be corresponsive to the keycap 2, and the micro LED 4 comprises an LED chip 41 and encapsulation layer an encapsulation layer 42, and the LED chip 41 is installed and electrically coupled to the membrane circuit board 3, and the encapsulation layer 42 is formed on the membrane circuit board 3 and completely covers the LED chip 41. The micro LED 4 has a length smaller than 400 microns, a width smaller than 250 microns, and a height smaller than 150 microns.

Specifically, the LED chip 41 is installed and electrically coupled to the upper film 31. The encapsulation layer 42 comprises a chip protective layer 421 and a phosphor layer 422. The chip protective layer 421 is formed on the upper film 31 and completely covers the LED chip 41 to cover and protect the LED chip 41. The phosphor layer 422 is formed on the chip protective layer 421 and completely covers the chip protective layer 421. The phosphor layer 422 is provided for adjusting the wavelength of the LED chip 41, so that the micro LED 4 can emit a color light including a white light. The chip protective layer 421 is made of resin, and the phosphor layer 422 is made of a mixture of resin and phosphor.

In addition, the luminous press key module 10 of this disclosure further comprises a flexible thin film layer 423 stacked on the upper film 31 and completely covers the phosphor layer 422. Since the upper film 31 has a circuit electrically coupled to the LED chip 41, the flexible thin film layer 423 can be used for covering and protecting the circuit electrically coupled to the LED chip 41. Wherein, the flexible thin film layer 423 is a thin film made of a plastic material such as PET, PC, TPU, PMMA, etc.

In FIG. 1, the luminous press key module 10 of this disclosure further comprises an elastic body 5 supported between the keycap 2 and the upper film 31, and the elastic body 5 has a recessed containing groove 51 inwardly formed at the bottom of the elastic body 5 and a protruding block 52 extended from an inner wall of the recessed containing groove 51 and configured to be corresponsive to the first conductive circuit 311 and capable of pushing the first conductive circuit 311 to be attached on the second conductive circuit 321 to generate a press key signal, and the elastic body 5 is provided for pushing the keycap 2 upward to restore its original position.

Wherein, the micro LED 4 is configured to be corresponsive to the interior of the recessed containing groove 51, and the elastic body 5 is made of a light-transmitting material, so that the micro LED 4 may make use of the light-transmitting material of the elastic body 5 to transmit light, and transmit light from the gap between the keycap 2 and the bottom plate 1, or the micro LED 4 can transmit light through the light-transmitting material of the elastic body 5 and the keycap 2.

In FIG. 1, the luminous press key module 10 of this disclosure further comprises a scissor-type frame 6 with an end coupled to the bottom plate 1 and the other end coupled to the keycap 2, and the keycap 2 is coupled to the bottom plate 1 through the scissor-type frame 6 and capable of moving up and down with respect to the bottom plate 1.

With reference to FIGS. 1 and 2 for the using status of the luminous press key module 10 of this disclosure, this disclosure makes use of the feature of the small volume of the micro LED 4 to install the micro LED 4 on the membrane circuit board 3 directly, and the micro LED 4 can emit light directly from the gap between the keycap 2 and the bottom plate 1, or the micro LED 4 can emit light directly through the light-transmitting material of the keycap 2 to omit the component of the conventional light guide plate, so as to achieve the effects of reducing the thickness of the luminous press key module 10 and providing the advantageous features of a light, thin, short and compact design of the luminous press key module 10.

With reference to FIG. 3 for the micro LED 4 in accordance with the second embodiment of this disclosure, the micro LED 4 of the second embodiment is substantially the same as the micro LED 4 of the first embodiment, except that the structure of the flexible thin film layer 423′ is different.

Further, the flexible the thin film layer 423′ has one or more through holes 4231, and the quantity of the through holes 4231 is equal to the quantity of the micro LEDs 4, and the flexible thin film layer 423′ is stacked on the upper film 31, and the micro LED 4 is embedded into the through hole 4231, and the encapsulation layer 42 is exposed from the through hole 4231. Since the upper film 31 has a circuit electrically coupled to the LED chip 41, and the flexible thin film layer 423′ is primarily provided for covering and protecting the circuit electrically coupled to the LED chip 41, it is not necessary to cover the flexible thin film layer 423′ onto the encapsulation layer 42. In the meantime, this arrangement also can prevent the thickness at the position of the micro LED 4 from being too thick (by omitting the thickness of the flexible thin film layer 423′). Wherein, the flexible thin film layer 423′ is a thin film made of a plastic material such as PET, PC, TPU, PMMA, etc.

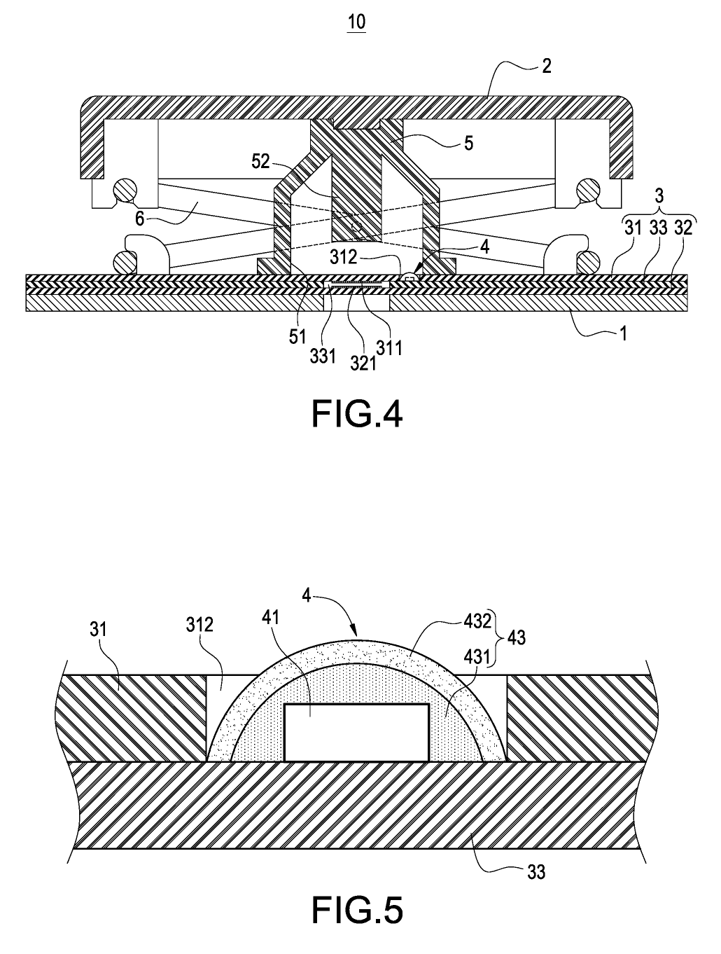

With reference to FIGS. 4 and 5 for the luminous press key module 10 of the second embodiment and the micro LED 4 of the third embodiment of this disclosure respectively, the luminous press key module 10 of the second embodiment is substantially the same as the luminous press key module 10 of the first embodiment, except that the LED chip 41 is installed and electrically coupled to the spacer film 33.

In the micro LED 4 of the third embodiment, the LED chip 41 is installed and electrically coupled to the spacer film 33, and the encapsulation layer 43 comprises a chip protective layer 431 and a phosphor layer 432, and the chip protective layer 431 is formed on the spacer film 33 and completely covered onto the LED chip 41, and the phosphor layer 432 is formed on the chip protective layer 431 and completely covered onto the chip protective layer 431.

In addition, the upper film 31 has one or more first hollow holes 312, and the quantity of the first hollow holes 312 is equal to the quantity of the micro LEDs 4, and the micro LED 4 is embedded into the first hollow hole 312, and the encapsulation layer 43 is exposed from the first hollow hole 312. Since the spacer film 33 has a circuit electrically coupled to the LED chip 41, the upper film 31 can cover and protect the circuit electrically coupled to LED chip 41 directly.

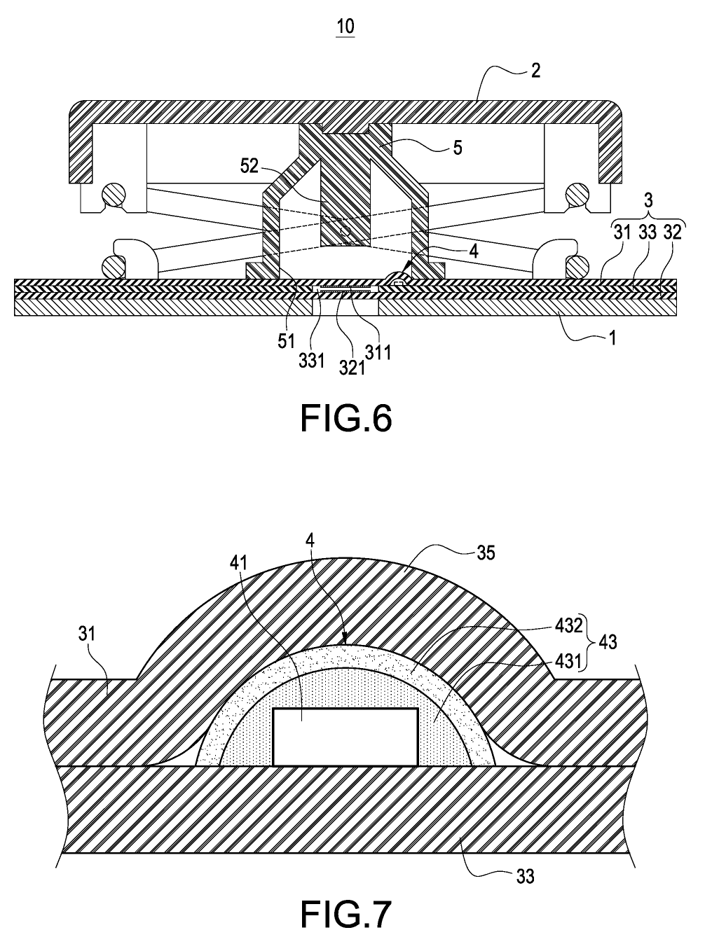

With reference to FIGS. 6 and 7 for the luminous press key module 10 of the third embodiment and the micro LED 4 of the fourth embodiment of this disclosure respectively, the luminous press key module 10 of the third embodiment is substantially the same as the luminous press key module 10 of the second embodiment, except that the structure of the upper film 31 is different.

Further, the upper film 31 has one or more circuit free areas 35, and the quantity of the circuit free areas 35 is equal to the quantity of the micro LEDs 4, and the circuit free areas 35 are covered on the encapsulation layer 43 and completely covered onto the encapsulation layer 43. Since the spacer film 33 has a circuit electrically coupled to the LED chip 41, the upper film 31 can cover and protect the circuit electrically coupled to LED chip 41 directly. Wherein, no circuit is designed in the circuit free area 35 to prevent affecting the brightness of the LED chip 41.

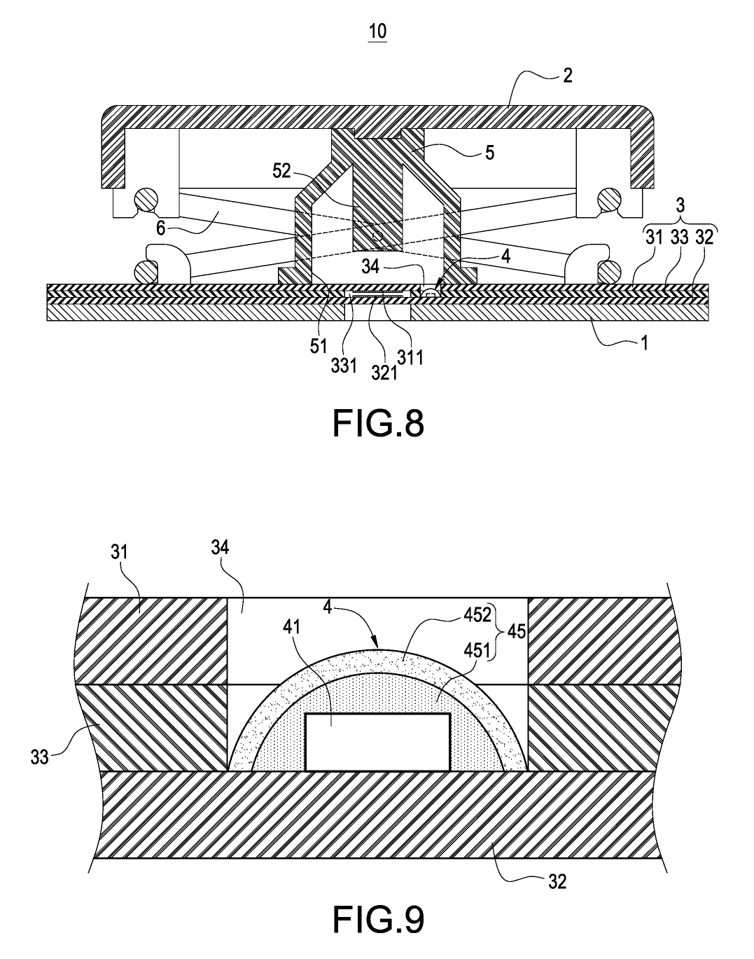

With reference to FIGS. 8 and 9 for the luminous press key module 10 of the fourth embodiment and the micro LED 4 of the fifth embodiment of this disclosure respectively, the luminous press key module 10 of the fourth embodiment is substantially the same as the luminous press key module 10 of the second embodiment, except that the LED chip 41 is installed and electrically coupled to the lower film 32.

In the micro LED 4 of the fifth embodiment, the LED chip 41 is installed and electrically coupled to the lower film 32, and the encapsulation layer 45 comprises a chip protective layer 451 and a phosphor layer 452, and the chip protective layer 451 is formed on the lower film 32 and completely covered onto the LED chip 41, and the phosphor layer 452 is formed on the chip protective layer 451 and completely covered onto the chip protective layer 451.

In addition, the upper film 31 and the spacer film 33 jointly have one or more second hollow holes 34, and the quantity of the second hollow holes 34 is equal to the quantity of the micro LEDs 4, and the micro LED 4 is embedded into the second hollow hole 34, and the encapsulation layer 43 is exposed from the second hollow hole 34. Since the lower film 32 has a circuit electrically coupled to the LED chip 41, the spacer film 33 can cover and protect the circuit electrically coupled to LED chip 41 directly.

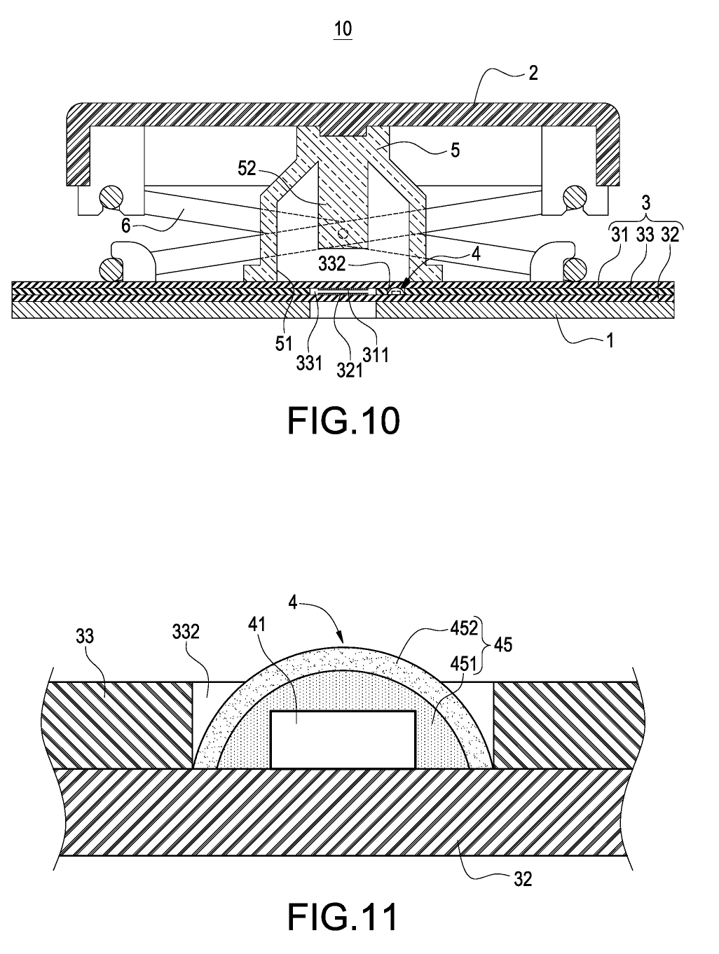

With reference to FIGS. 10 and 11 for the luminous press key module 10 of the fifth embodiment and the micro LED 4 of the sixth embodiment of this disclosure respectively, the luminous press key module 10 of the fifth embodiment is substantially the same as the luminous press key module 10 of the fourth embodiment, except that the structures of the upper film 31 and the spacer film 33 are different.

Specifically, the upper film 31 has no hollow hole formed thereon, but the spacer film 33 has one or more third hollow holes 332, and the quantity of the third hollow holes 332 is equal to the quantity of the micro LEDs 4. In the micro LED 4 of the sixth embodiment, the micro LED 4 is embedded into the third hollow hole 332 and installed and sealed between the upper film 31 and the lower film 32. Since the lower film 32 has a circuit electrically coupled to the LED chip 41, the spacer film 33 can cover and protect the circuit electrically coupled to the LED chip 41 directly.

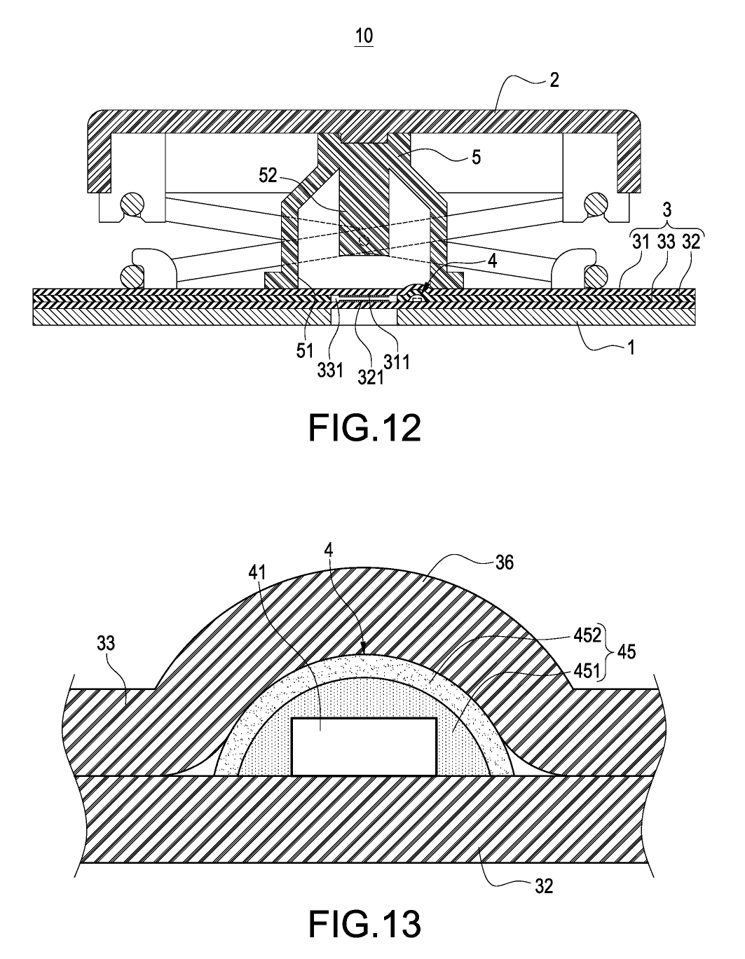

With reference to FIGS. 12 and 13 for the luminous press key module 10 of the sixth embodiment and the micro LED 4 of the seventh embodiment of this disclosure respectively, the luminous press key module 10 of the sixth embodiment is substantially the same as the luminous press key module 10 of the fourth embodiment, except that the structures of the upper film 31 and the spacer film 33 are different.

Further, both of the upper film 31 and the spacer film 33 have no hollow hole formed thereon. In the micro LED 4 of the seventh embodiment, the upper film 31 and the spacer film 33 jointly have one or more circuit free areas 36, and the quantity of the circuit free areas 36 is equal to the quantity of the micro LEDs 4, and the circuit free areas 36 are covered on the encapsulation layer 43 and completely covered onto the encapsulation layer 43. Since the lower film 32 has a circuit electrically coupled to the LED chip 41, the spacer film 33 can cover and protect the circuit electrically coupled to the LED chip 41 directly. Wherein, no circuit is designed in the circuit free area 36 to prevent affecting the brightness of the LED chip 41.

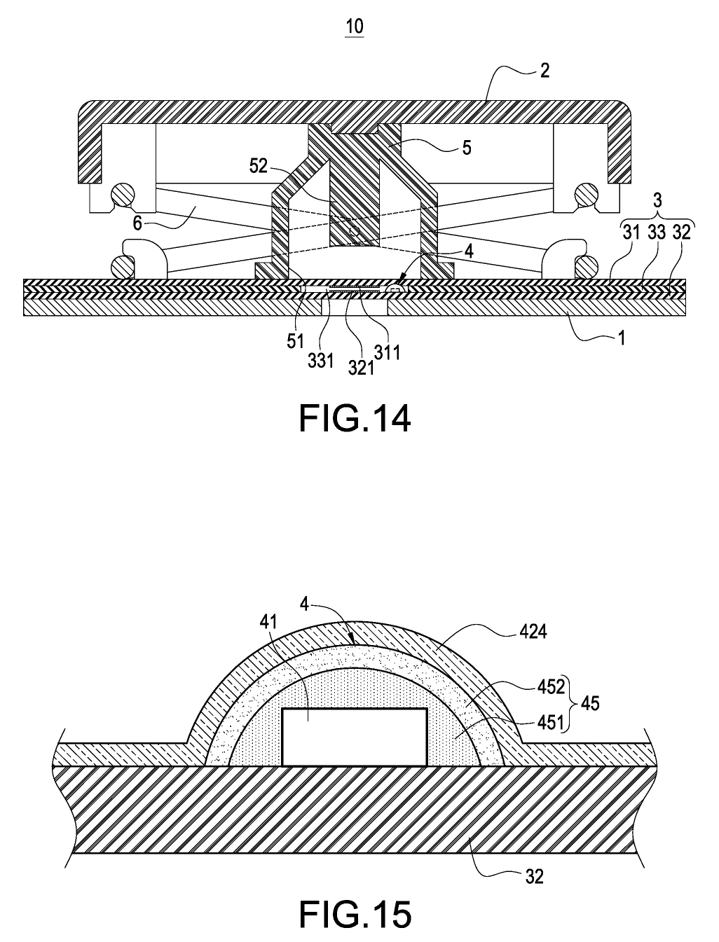

With reference to FIGS. 14 and 15 for the luminous press key module 10 of the seventh embodiment and the micro LED 4 of the eighth embodiment of this disclosure respectively, the luminous press key module 10 of the seventh embodiment is substantially the same as the luminous press key module 10 of the fourth embodiment, except that the micro LED 4 is accommodated in the penetrating hole 331.

Specifically, the micro LED 4 is accommodated in the penetrating hole 331. In the micro LED 4 of the eighth embodiment, the luminous press key module 10 further comprises a flexible thin film layer 424 stacked on the lower film 32 and the encapsulation layer 43 and completely covered onto the encapsulation layer 43. Since the lower film 32 has a circuit electrically coupled to the LED chip 41, the flexible thin film layer 424 is provided for covering and protecting the circuit electrically coupled to the LED chip 41. Wherein, the flexible thin film layer 424 is a thin film made of a plastic material such as PET, PC, TPU, PMMA, etc.

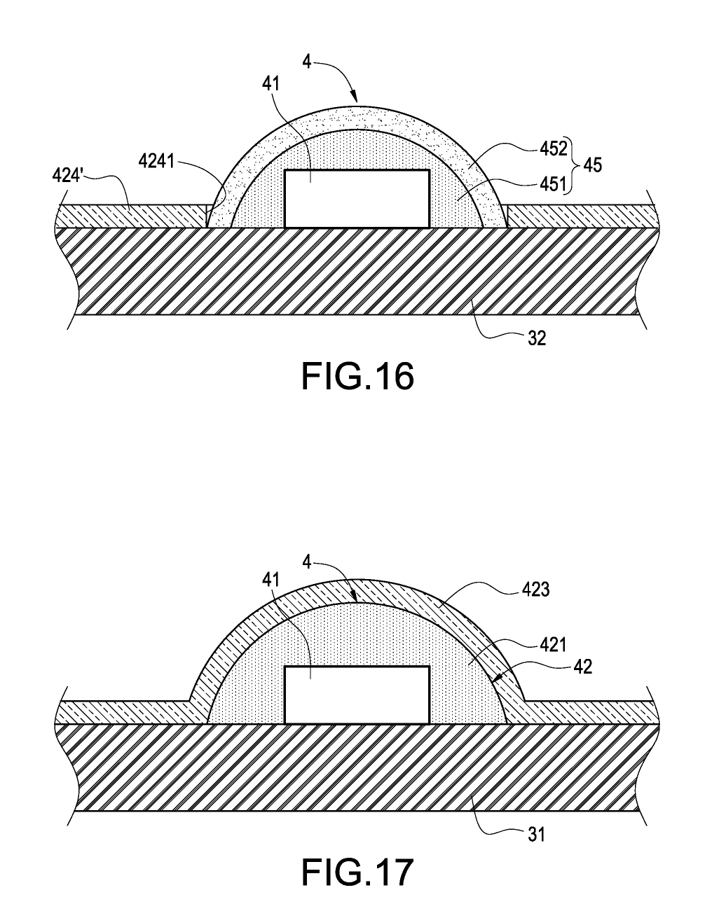

With reference to FIG. 16 for the micro LED 4 of the ninth embodiment of this disclosure, the micro LED 4 of the ninth embodiment is substantially the same as the micro LED 4 of the eighth embodiment except that the structure of the flexible thin film layer 424′ is different.

Further, the flexible thin film layer 424′ has one or more through holes 4241, and the quantity of the through holes 4241 is equal to the quantity of the micro LEDs 4, and the flexible thin film layer 424′ is stacked on the lower film 32, and the micro LED 4 is embedded into the through hole 4241, and the encapsulation layer 45 is exposed from the through hole 4241. Since the lower film 32 has a circuit electrically coupled to the LED chip 41, and the flexible thin film layer 424′ is primarily provided for covering and protecting the circuit electrically coupled to the LED chip 41, it is not necessary to cover the flexible thin film layer 424′ onto the encapsulation layer 45. In the meantime, this arrangement also can prevent the thickness at the position of the micro LED 4 from being too thick (by omitting the thickness of the flexible thin film layer 424′). Wherein, the flexible thin film layer 424′ is a thin film made of a plastic material such as PET, PC, TPU, PMMA, etc.

With reference to FIG. 17 for the micro LED 4 of the tenth embodiment of this disclosure, the micro LED 4 of the tenth embodiment is substantially the same as the micro LED 4 of the first embodiment except that it is not necessary to adjust the wavelength of the LED chip 41 of the tenth embodiment, so that the encapsulation layer 42 does not include any phosphor layer, but the encapsulation layer 42 simply includes the chip protective layer 421 formed on the upper film 31 and completely covered onto the LED chip 41.

Similarly, in the micro LED 4 according to the second to ninth embodiments, the encapsulation layer may omit the phosphor layer, so that the encapsulation layer just includes the chip protective layer when it is not necessary to adjust the wavelength of the LED chip 41.

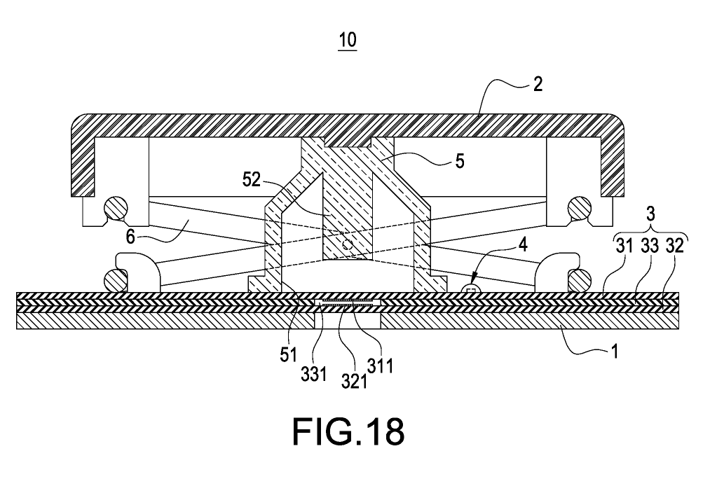

With reference to FIG. 18 for the luminous press key module 10 in accordance with the eighth embodiment of this disclosure, the luminous press key module 10 of the eighth embodiment is substantially the same as the luminous press key module 10 of the first embodiment, except that the micro LED 4 is configured to be corresponsive to the outer side of the elastic body 5, so that the micro LED 4 can emit light directly from the gap between the keycap 2 and the bottom plate 1, or the micro LED 4 can emit light directly through the light-transmitting material of the keycap 2 to achieve the same functions and effects of the luminous press key module 10 of the first embodiment.

Similarly, the micro LED 4 in accordance with the first to tenth embodiments may be configured to be corresponsive to the outer side of the elastic body 5.

In summation of the description above, the luminous press key module this disclosure is novel, useful, non-obvious, and inventive and complies with the patent application requirements, and thus the disclosure is duly filed for patent application.

While this disclosure has been described by means of specific embodiments, numerous modifications and variations could be made thereto by those skilled in the art without departing from the scope and spirit of this disclosure set forth in the claims.

What is claimed is:

1. A luminous press key module, comprising:
a bottom plate;
a keycap, installed above the bottom plate;
a membrane circuit board, installed between the bottom plate and the keycap; and
at least a micro LED, installed and electrically coupled to the membrane circuit board, the micro LED being arranged corresponding to the keycap.

2. The luminous press key module of claim 1, wherein the micro LED includes an LED chip and an encapsulation layer, the LED chip is installed and electrically coupled to the membrane circuit board, and the encapsulation layer is formed on the membrane circuit board and completely covers the LED chip.

3. The luminous press key module of claim 2, wherein the membrane circuit board includes an upper film, a lower film, and a spacer film, the spacer film is held between the upper film and the lower film, the spacer film includes a penetrating hole, a first conductive circuit disposed corresponding to the penetrating hole is arranged on a bottom surface of the upper film, and a second conductive circuit disposed corresponding to the penetrating hole is arranged on a top surface of the lower film.

4. The luminous press key module of claim 3, wherein the LED chip is installed and electrically coupled to the upper film, the encapsulation layer includes a chip protective layer and a phosphor layer, the chip protective layer is formed on the upper film and completely covers the LED chip, and the phosphor layer is formed on the chip protective layer and completely covers the chip protective layer.

5. The luminous press key module of claim 3, wherein the LED chip is installed and electrically coupled to the upper film, the encapsulation layer includes a chip protective layer, and the chip protective layer is formed on the upper film and completely covers the LED chip.

6. The luminous press key module of claim 3, further comprising a flexible thin film layer stacked on the upper film and the encapsulation layer and completely covering the encapsulation layer.

7. The luminous press key module of claim 3, further comprising a flexible thin film layer with at least a through hole, the flexible thin film layer being stacked on the upper film, the micro LED being embedded into the through hole, and the encapsulation layer being exposed from the through hole.

8. The luminous press key module of claim 3, wherein the LED chip is installed and electrically coupled to the spacer film, the encapsulation layer includes a chip protective layer and a phosphor layer, the chip protective layer is formed on the spacer film and completely covers the LED chip, and the phosphor layer is formed on the chip protective layer and completely covers the chip protective layer.

9. The luminous press key module of claim 3, wherein the LED chip is installed and electrically coupled to the spacer film, the encapsulation layer includes a chip protective layer, and the chip protective layer is formed on the spacer film and completely covers the LED chip.

10. The luminous press key module of claim 3, wherein the upper film includes at least a first hollow hole, the micro LED is embedded into the first hollow hole, and the encapsulation layer is exposed from the first hollow hole.

11. The luminous press key module of claim 3, wherein the upper film includes at least a circuit free area, and the circuit free area is disposed on the encapsulation layer and completely covers the encapsulation layer.

12. The luminous press key module of claim 3, wherein the LED chip is installed and electrically coupled to the lower film, the encapsulation layer includes a chip protective layer and a phosphor layer, the chip protective layer is formed on the lower film and completely covers the LED chip, and the phosphor layer is formed on the chip protective layer and completely covers the chip protective layer.

13. The luminous press key module of claim 3, wherein the LED chip is installed and electrically coupled to the lower film, the encapsulation layer includes a chip protective layer, and the chip protective layer is formed on the lower film and completely covers the LED chip.

14. The luminous press key module of claim 3, wherein the upper film and the spacer film jointly have at least a second hollow hole, the micro LED is embedded into the second hollow hole, and the encapsulation layer is exposed from the second hollow hole.

15. The luminous press key module of claim 3, wherein the spacer film includes at least a third hollow hole, and the micro LED is embedded into the third hollow hole and installed between the upper film and the lower film.

16. The luminous press key module of claim 3, wherein the upper film and the spacer film jointly include at least a circuit free area, and the circuit free area is disposed on the encapsulation layer and completely covers the encapsulation layer.

17. The luminous press key module of claim 3, further comprising a flexible thin film layer, the micro LED being accommodated into the penetrating hole, the flexible thin film layer being stacked on the lower film and the encapsulation layer and completely covering the encapsulation layer.

18. The luminous press key module of claim 3, further comprising a flexible thin film layer, the micro LED being accommodated into the penetrating hole, the flexible thin film layer having at least a through hole, the flexible thin film layer being stacked on the lower film, the micro LED being embedded into the through hole, and the encapsulation layer being exposed from the through hole.

19. The luminous press key module of claim 3, further comprising an elastic body supported between the keycap and the upper film, the elastic body including a recessed containing groove inwardly formed at the bottom of the elastic body, a protruding block being extended from an inner wall of the recessed containing groove and disposed corresponding to the first conductive circuit, the protruding block being used to push the first conductive circuit to contact the second conductive circuit, and the micro LED being installed on an outer side of the elastic body.

20. The luminous press key module of claim 3, further comprising an elastic body supported between the keycap and the upper film, the elastic body including a recessed containing groove inwardly formed at the bottom of the elastic body and a protruding block extended from an inner wall of the recessed containing groove, the protruding block being disposed corresponding to the first conductive circuit and being used to push the first conductive circuit to contact the second conductive circuit, the micro LED being disposed corresponding to the interior of the recessed containing groove, and the elastic body consisting of a light-transmitting material.
